(19) United States
(12) Patent Application Publication
(10) Pub. No.: US 2013/0209804 A1
(43) Pub. Date: Aug. 15, 2013

(54) Mecanical Structures Made Of Regular Pentagonal Dodecahedrons

(71) Applicant: Olivier/ Jean-Marie/Ren's GORRE, Sceaux (FR)

(72) Inventor: Olivier/ Jean-Marie/Ren's GORRE, Sceaux (FR)

(21) Appl. No.: 13/711,641

(22) Filed: Dec. 12, 2012

(30) Foreign Application Priority Data
Dec. 20, 2011 (FR) 1103964

(51) Int. Cl. B64C 1/00

(52) U.S. Cl. CPC B64C 1/00
USPC 428/402

(57) ABSTRACT

We invented that it is possible to make a mechanical structure without void between elements with regular pentagonal dodecahedrons.

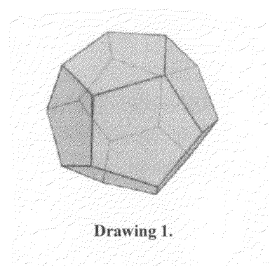

So, it is possible to produce very tough and light mechanical structures or materials with the best efficiency and optimization of tough versus used matter in a taken volume (better than honeycombs).

The void inside the mechanical structure (inside dodecahedrons) is the best optimization of the given matter, given total volume and wanted tough and wanted void volume inside the elements (dodecahedrons).

We discovered that it is possible to produce mechanical structures with regular pentagonal totally or partially void dodecahedrons without any void between dodecahedron elements (Drawing 1).

The tough of the structure versus used matter amount and taken volume is optimized and the best possible and very better than honeycomb structures used for example in aerospace industry.

Microscopic structures made of molecular, small microscopic segments or crystallographic regular dodecahedron lattices is also possible and can produce very though material versus weight of the material.

In the aim to produce that mechanical structure it is possible to glue the regular dodecahedron elements faces. It is also possible to make tips or spikes or solder points on faces of the regular pentagonal dodecahedrons in the aim to produce welding (solder) with electrical current passing throw the metallic dodecahedron and the metallic mechanical structure in construction.

1) Mechanical structure made of regular pentagonal totally or partially void dodecahedrons.

2) Material made of crystallographic or molecular or small segments of regular pentagonal dodecahedrons lattice.
